(19) United States
(12) Patent Application Publication
(10) Pub. No.: US 2008/0038618 A1
(43) Pub. Date: Feb. 14, 2008

(54) FUEL CELL SYSTEM

(75) Inventors: Hitoshi NAITO, Tsukuba-shi (JP); Yoshitsugu SONE, Sagamihara-shi (JP); Mitsushi UENO, Tsukuba-shi (JP)

Correspondence Address: GRIFFIN & SZIPL, PC, SUITE PH-1, 2300 NINTH STREET, SOUTH, ARLINGTON, VA, 22204, US

(73) Assignee: JAPAN AEROSPACE EXPLORATION AGENCY, Tokyo (JP)

(21) Appl. No.: 11/838,144

(22) Filed: Aug. 13, 2007

(30) Foreign Application Priority Data
Aug. 14, 2006 (JP) 2006-221055

(51) Int. Cl. H01M 8/06

(52) U.S. Cl. 429/34; 417/313

(57) ABSTRACT

There is provided a fuel cell system having a moisture mixture separating mechanism capable of separating produced water in high purity. While a sheet member closes an outlet port of a drain port and an inlet port of a drain passage by closely adhering to an outlet-side opening end of the drain port and an inlet-side opening end of the drain passage in a state when hydraulic pressure within a Pitot tube is low, it elastically deforms and separates from the opening ends of the drain port and drain passage when the hydraulic pressure within the Pitot tube increases, thus communicating the outlet-side opening end of the drain port with the inlet-side opening end of the drain passage and discharging water in the drain port to the drain passage.

### BACKGROUND OF THE INVENTION

1. Field of the Invention

The present invention relates to a drainage mechanism for separating moisture from gas in a moisture mixture emitted out of a fuel cell to drain water by utilizing hydraulic pressure, to a moisture separating system using the drainage mechanism and to a fuel cell system incorporating the moisture separating system and capable of accommodating to a micro-gravity environment and/or closed environment.

2. Description of the Related Art

Since the US National Aeronautics and Space Administration (NASA) finished a demonstration of a fuel cell in a flight test of 30 minutes by actually mounting and utilizing it in a spacecraft in 1960's for the first time, fuel cells have been used as power sources of manned spacecrafts such as Gemini, Apollo, Space Shuttle and others. The fuel cell is an extremely effective power generator specifically for a spacecraft and the like that require a large electric power (Wh). However, there have been the following technological problems in applying the fuel cell to spacecrafts.
1) How to convey and maintain whole fuel and/or oxidant during an operation period;
2) How to maintain air-tightness (eliminate drain to the outside) under an environment in which lead-in passages are closed; and
3) How to remove produced water under the micro-gravity.

While the fuel cell produces water together with electricity, it needs a mechanism for removing water because gas and liquid are not readily separated on an orbit in the micro-gravity environment (10⁻⁶ to 10⁻⁸ G). Still more, because no fuel and oxidant can be supplied from the outside, everything including active substances and others necessary for the reaction of the cell must be stored within the closed spacecraft and it is essential to reduce weight and to compact the fuel cell to reduce a load in launching a rocket. Then, a technology for separating and removing water is important to maintain the effective power generation in a power generating section because reaction produced water produced by an electrochemical reaction around an electrolyte film/electrode/oxide gas becomes a reaction blocking substance if it gathers there and must be efficiently removed.

On the ground, the moisture separation is performed by mainly using a method of condensing produced water by using cooling water or the like and of separating gas and condensed water by utilizing gravity as disclosed in Japanese Unexamined Patent Application Publication No. 6-76843 Gazette for example. However, since the moisture separation cannot be performed by utilizing gravity in the micro-gravity environment such as the space, a method of condensing produced water by using the principle of centrifugation to separate water is used in the Space Shuttle and others. There also has been a moisture separating method of using an absorbent as disclosed in Japanese Unexamined Patent Application Publication No. 2004-317747 Gazette.

The fuel cell specifically used in the spacecraft must utilize the mounted fuel and oxidant gas as much as possible and must prevent the non-reacted substances from being emitted without reaction in order to generate electricity while holding all the main body, fuel and oxidant of the fuel cell power generating system within a restricted space (capacity) and mass. Then, to that end, it is necessary to provide a fuel cell system having a moisture mixture separating mechanism capable of separating reaction produced water in high purity.

### SUMMARY OF THE INVENTION

In order to solve the above-mentioned problem, the present invention is arranged as follows.

That is, according to a first aspect of the invention, there is provided a circulating pump for taking in a moisture mixture containing reaction produced water and non-reacted gas at least from either one of an fuel outlet port and an oxidant outlet port of a fuel cell and for refluxing the non-reacted gas to an inlet port of the gas of the fuel cell, including a pump casing having an intake port communicating with a lead-in passage for leading in the moisture mixture at least from either one of the fuel outlet port and oxidant outlet port of the fuel cell and a discharge port for sending the non-reacted gas to the inlet port of the gas of the fuel cell, impellers disposed within the pump casing, a moisture trap, provided around the center of a front face of the impellers so as to rotate together with the impellers, for trapping moisture within the moisture mixture led into the pump casing via the intake port, a water collecting section, provided in communication with the moisture trap, for storing water drained out of the moisture trap by rotation of the moisture trap in a state of receiving centrifugal force and a drainage mechanism for draining water in the water collecting section out of the water collecting section.

According to a preferred aspect of the invention, the circulating pump further includes a drain port for draining water from the water collecting section and a drain passage, provided in close proximity to the drain port, for draining water from the drain port, and the drainage mechanism includes a Pitot tube whose one end communicates with the water collecting section by opening within water in the water collecting section and whose other end communicates with the drain port and a sheet member that closes an outlet port of the drain port and an inlet port of the drain passage by closely adhering to the outlet-side opening end of the drain port and the inlet-side opening end of the drain passage in a state when hydraulic pressure within the Pitot tube is low and that elastically deforms and separates from the opening ends of the drain port and drain passage when the hydraulic pressure within the Pitot tube increases, thus communicating the outlet-side opening end of the drain port with the inlet-side opening end of the drain passage and discharging water in the drain port to the drain passage. The inventors of the present invention have found that water from the drain port is selectively drained to the side of the drain passage and no gaseous component is emitted by the operation of this sheet member. This sheet member is typically and preferably composed of a panel member flexible to a degree of guaranteeing the operation described above. For instance, a polymer material such as Teflon (registered mark) formed into a thin sheet may be preferably used.

According to another aspect of the invention, the circulating pump further includes an urging member, disposed closely behind the sheet member for pressing the sheet member toward the opening of the drain port by its elastic force. In this case, a spring member such as a coil spring is typically used as an elastic body. It is also preferable to dispose a pressing member having a flat surface at an edge of the urging member such as the spring so that the flat surface thereof closely adheres to the back of the sheet member in face-to-face contact. Thereby, pressure from the urging member is uniformly transmitted to the sheet member and the sheet member closely adheres to peripheral edges of the opening ends of the drain port and drain passage by the uniform pressure when the elastic force is given to the back of the urging member by the member such as the spring. Although it is possible to construct such that the sheet member closely adheres to the peripheral edges of the opening end of the drain port by arranging so that the sheet member contacts with the urging member face-to-face, it is not always necessary to do so and it is also possible to arrange so that the sheet member is pressed through contact of a plurality of points of more than one.

It is also desirable to create a space behind the urging member and to dispose a pressure equalizing tube that communicates that space with the lead-in passage. Thereby, even if a difference of pressure is generated between the inside and outside of the pump casing, produced water in the water collecting section may be drained to the outside of the system without trouble.

Furthermore, according to a preferred aspect of the invention, the moisture trap is composed of a gas transmitting porous material disposed so as to extend from a front part of the impellers at an end of the gas lead-in section and a rotary center part of the impellers toward the outside in a radial direction.

Preferably, the moisture mixture containing produced water and non-reacted gas is guided to the intake port of the pump along a rotary shaft of the impellers, collides against the moisture trap at the front center part of the impellers, thus changing its advancing direction in an orthogonal direction along front walls of the impellers, is guided toward the outside in the radial direction and is guided to the emitting port of the pump casing. Moisture within the moisture mixture from the fuel cell may be effectively separated by thus changing the flow of the moisture mixture.

Preferably, an output shaft of a magnet motor is coupled to the impellers so as to be able to transmit power. Thereby, it becomes possible to enhance a safety and a degree of freedom in designing the apparatus. According to another aspect of the invention, an output shaft of a brushless motor is coupled to the impellers so as to be able to transmit power from the aspect of safety.

Basically, the apparatus described above may be preferably used in a micro-gravity environment.

According to another aspect of the invention, there is provided a drain valve including a water collecting section capable of storing water receiving a centrifugal force, a drain port for draining water from the water collecting section, a Pitot tube whose one end communicates with the water collecting section by opening within water of the water collecting section and whose other end communicates with the drain port, a drain passage, provided in close proximity to the drain port, for draining water from the drain port and a sheet member arranged so as to close both of an outlet port of the drain port and an inlet port of the drain passage by closely adhering to the outlet-side opening end of the drain port and the inlet-side opening end of the drain passage. The sheet member operates so as to close the both of the outlet port of the drain port and the inlet port of the drain passage by closely and concurrently adhering to the outlet-side opening end of the drain port and the inlet-side opening end of the drain passage in a state when hydraulic pressure within the Pitot tube is low and so as to intermittently communicate the outlet-side opening end of the drain port with the inlet-side opening end of the drain passage to discharge water in the drain port to the drain passage when the hydraulic pressure within the Pitot tube increases.

According to another aspect of the invention, there is provided a fuel cell system including a fuel cell for generating electric power through an electro-chemical reaction of gas supplied to a fuel electrode side with gas supplied to an oxidant electrode side and a circulating pump for taking in a moisture mixture containing reaction produced water and non-reacted gas at least from either one of an fuel outlet port and an oxidant outlet port of the fuel cell and for refluxing the non-reacted gas to an inlet port of the gas, including a pump casing having an intake port communicating with a lead-in passage for leading in the moisture mixture at least from either one of the fuel outlet port and oxidant outlet port of the fuel cell and a discharge port for sending non-reacted gas to the inlet port of the gas, impellers disposed within the pump casing, a moisture trap, provided around the center of a front face of the impellers so as to rotate together with the impellers, for trapping moisture within the moisture mixture led into the pump casing, a water collecting section, provided in communication with the moisture trap, for storing water drained out of the moisture trap by rotation of the moisture trap in a state of receiving a centrifugal force, and a drainage mechanism for draining water of the water collecting section out of the water collecting section.

In this case, the feature of the invention may be effectively utilized by forming the fuel cell system in which the closed circulating path is formed by connecting the discharge port of gas at least from the oxidant electrode side among the fuel electrode and the oxidant electrode to the path for supplying the gas to the oxidant electrode side and by providing the condenser in the closed circulating path.

The present invention is preferable in an aspect of supplying the fuel and oxidant gases to the condenser from supply sources without moisture. The present invention provides the unique drain valve arranged to balance the pressure between the drain port and the moisture trap by utilizing hydraulic pressure and by regulating differential pressure between the inside and outside of the pump. It is also possible to provide the circulating pump capable of being used in circulating and pressurizing flammable gas by adopting the brushless motor. The use of the drain valve and the circulating pump described above provides the moisture separating system that can effectively conduct the moisture separation under the micro-gravity environment such as the space. Furthermore, it becomes possible to provide the fuel cell system that efficiently separates the non-reacted gas and the reaction produced water contained in the emission side in generating power by the fuel cell, returns only the non-reacted gas to the supply system and effectively and actively uses the gas so that it contributes in power generation. It is also possible to realize the fuel cell system that can be used in a closed environment on the ground, in which emission of gas is hated, other than the space environment, by constructing the system that emits no exhaust other than water. The system has the water drainage mechanism that utilizes the difference between the hydraulic pressure generated by the mass of water and the atmospheric pressure. The arrangement described above provides the arrangement of condensing and separating water from the non-reacted gas containing produced water. The moisture separating apparatus is characterized in that it obtains water collected by receiving the centrifugal force caused by the rotation of the impellers. It is then possible to control an amount of collected produced water by varying a number of revolutions of the impellers. There is a merit that the motor will cause no ignition or explosion even under the oxidant (combustion supporting gas) by adopting the brushless motor as the motor for rotating the impellers as described above.

According to the present invention, the hydraulic pressure generated by the centrifugal force is utilized to drain water, so that only water may be separated from gas and be selectively drained and it becomes possible to prevent the non-reacted gas from dissipating to the outside of the system. Furthermore, because a large amount of produced water may be condensed and drained by increasing the number of revolutions, a small moisture separating system may be realized. It is also possible to circulate and utilize the combustion supporting gas by adopting the brushless motor or the magnet motor. The use of the moisture separating system of the invention allows the power generation by the fuel cell not only in the space environment in which gravity is very small but also in the closed environment on the ground in which emission of exhaust is hated.

### BRIEF DESCRIPTION OF THE DRAWINGS

FIG. 1 is a whole structural diagram of a fuel cell system capable of preferably and actively using the present invention;

FIG. 2 is a section view of a circulating pump according to a preferred embodiment of the invention;

FIG. 3 is a front view of the circulating pump in FIG. 2;

FIG. 4 is an enlarged section view of a part A (water collecting section) in FIG. 2;

FIG. 5 is an enlarged section view of a part B (drain valve) in FIG. 2, showing a state when the valve is closed; and

FIG. 6 is an enlarged section view of the part B (drain valve) in FIG. 2, showing a state when the valve is opened.

### DESCRIPTION OF THE PREFERRED EMBODIMENTS

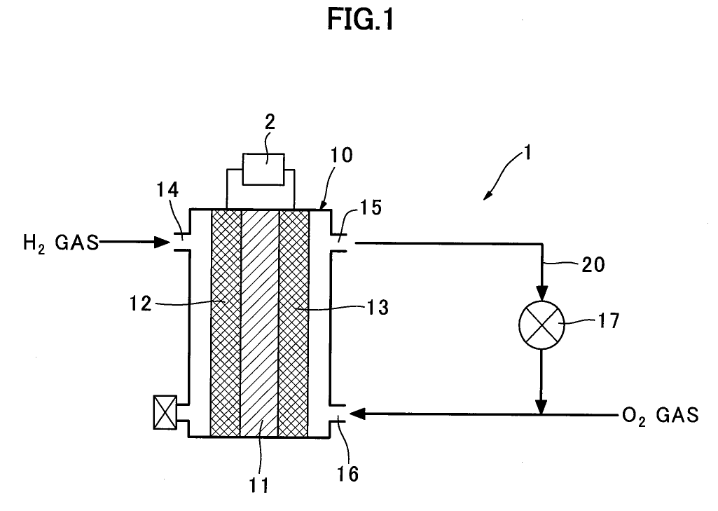

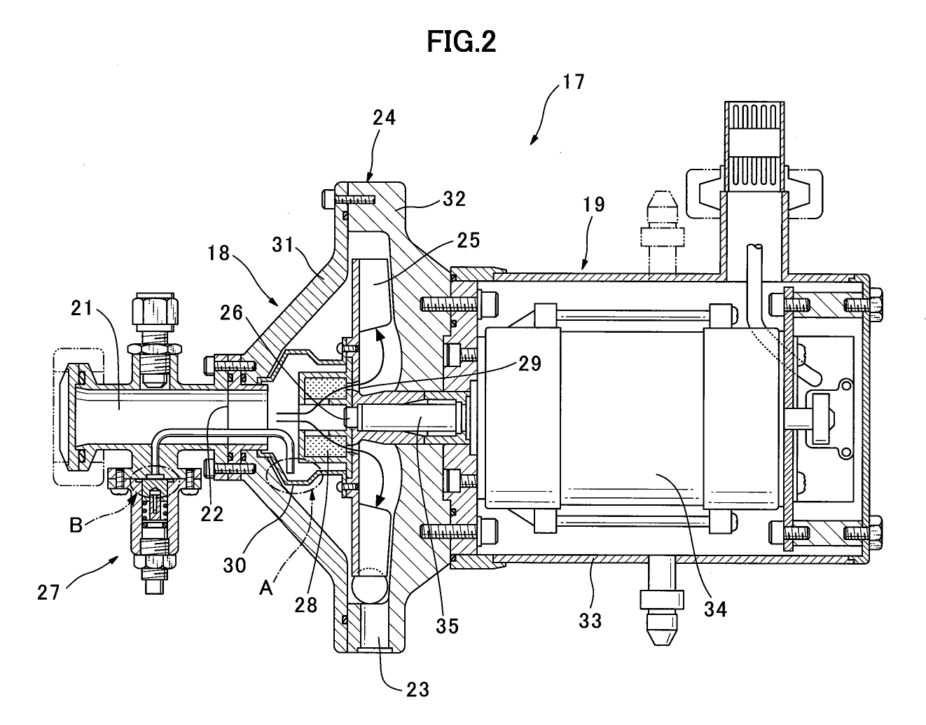

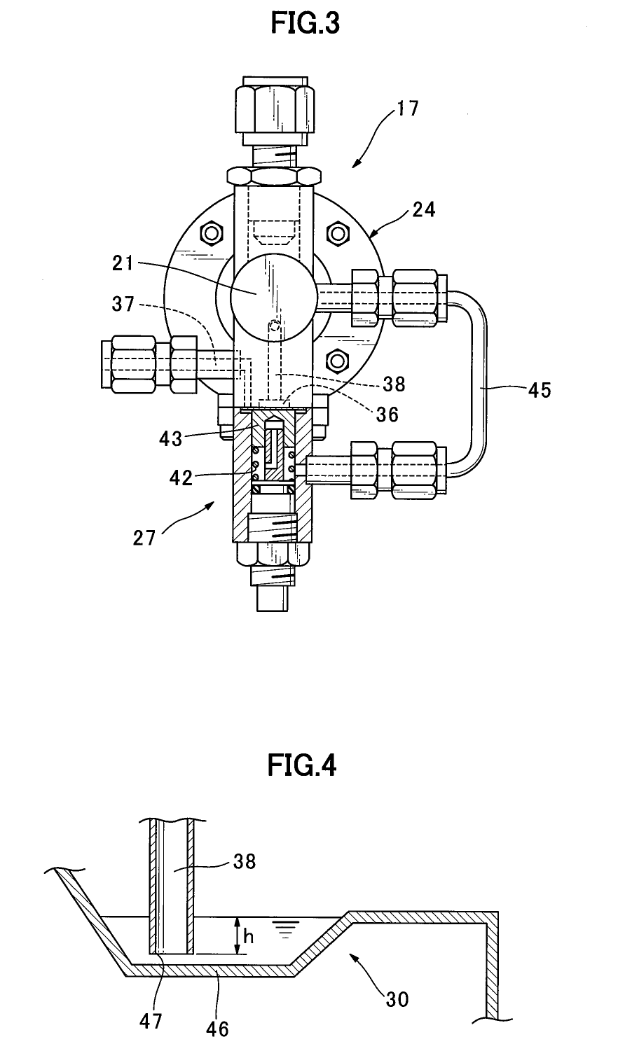

FIG. 1 is a whole structural diagram of a polymer electrolyte fuel cell system 1 according to a preferred embodiment of the invention. A polymer electrolyte fuel cell (fuel cell stack) 10 is constructed so that a fuel electrode 12 and an oxidant electrode 13 face each other while interposing a hydrogen ion electrolyte film 11 between them. The fuel electrode 12 and the oxidant electrode 13 are provided with a hydrogen supplying port 14 and an oxygen discharge port 15, respectively, at one side thereof and the oxidant electrode 13 is also provided with an oxygen supply port 16 at another side. In this example, an outlet port on the fuel side is closed so as to consume the fuel, i.e., pure hydrogen, within the fuel stack through reaction. It is noted that a load 2 consumes electricity generated by the fuel cell 10.

It is extremely desirable to enhance a utilization factor of the supplied gases in the fuel cell system and to that end, the system of using pure hydrogen and pure oxygen as the active substances and closing the fuel side gas discharge port is constructed as described above. However, produced water is stored and gathers within the oxygen electrode just by closing an oxygen-side circulation line, rapidly dropping performances of the fuel cell. Then, the polymer electrolyte fuel cell system 1 is arranged so as to connect the inlet and outlet ports of the fuel cell stack 10 as a closed-loop to suppress the residence of the produced water within the fuel cell on the oxygen side and to provide a circulating pump 17 between them in the loop to convey the produced water to the outside of the fuel cell stack 10 by a flow of circulating oxygen, to condense the produced water by the circulating pump 17 provided within the loop to discharge to the outside of the system and to efficiently separate, to recover and to circulate non-reacted oxidant gas. In addition to that, the system is arranged so that the inside of the fuel cell 10 is kept to be an adequate moisture environment by flowing hydrogen and oxygen as counterflows and by adequately setting an amount of oxygen to be circulated. Furthermore, in order to keep the power generation state for a long period of time, it is desirable to separate moisture produced and condensed within the fuel cell in the circulating pump within the closed loop from oxygen even under the micro-gravity and to discharge to the outside of the system without interrupting the power generation. The fuel cell system using the circulating pump of the invention can separate moisture efficiently even under such environment.

The circulating pump 17 of this example is composed of a pump section 18 for receiving and discharging the moisture mixture and a motor section 19 for giving rotary power necessary for the pump section 18. The circulating pump 17 intakes the moisture mixture containing reaction produced water and non-reacted gas from the oxidant emitting port 15 of the fuel cell 10 and refluxes the non-reacted gas to the fuel cell 10 and is connected to a lead-in passage 21 for leading in the moisture mixture from the oxidant gas outlet passage 20 of the fuel cell 10 through an intake port 22. The circulating pump 17 is provided with a pump casing 24 having the intake port 22 and an emitting port 23 for sending the non-reacted gas to the side of the oxidant inlet port of the fuel cell. Rotary vanes, i.e., impellers 25, are disposed within the pump casing 24. An intake side of the impellers communicates with the lead-in passage for leading in the moisture mixture from the outlet passage of the oxidant gas of the fuel cell. While the moisture mixture is guided to the lead-in passage from the outlet passage of the fuel cell, the lead-in passage 21 is provided along a rotary shaft 26 of the impellers cylindrically so as to surround it. Accordingly, the moisture mixture guided into the lead-in passage 21 is led into the circulating pump 17 along the rotary shaft 26 of the impellers 25 and hits against front walls of the impellers 25, changing its flow direction in an orthogonal direction. Then, the moisture mixture is guided toward the outside in a circumferential direction along a peripheral wall of the pump casing 24 and to the emitting port 23 provided at the outer periphery.

However, the present embodiment is arranged by incorporating a drainage mechanism (drain valve) 27 for separating the produced water and the non-reacted gas more effectively as an arrangement integrated with the circulating pump 17. Then, a moisture trap 28 for trapping moisture within the moisture mixture led into the pump casing 24 via the intake port is provided in the vicinity of the intake port 22 of the pump casing 24 communicating with the lead-in passage 21 of the moisture mixture in the circulating pump 17 of this embodiment. The moisture trap 28 is preferably composed of a porous material having gas permeability, e.g., sponge, and typically has a cylindrical or tubular shape having a common center axis with the rotary shaft 26 of the circulating pump 17. The moisture trap 28 is provided so as to be pasted to an intake port side of the impellers 25, i.e., to a center front face of the impellers 25. Thereby, the produced water and non-reacted gas taken in from the intake port of the pump casing 24 always collide against the moisture trap 28 and are guided so as to spread on the surface of the front wall of the impellers toward the outside in the radius direction. Under this arrangement, the moisture trap 28 efficiently separates the non-reacted oxidant gas and produced water by effectively and selectively trapping only moisture of the moisture mixture and passing the non-reacted gas. In this case, a plurality of openings 29 is provided at part of the center of the impellers 25 where the moisture trap 28 is disposed. Then, the moisture of the moisture mixture that collides against the moisture trap 28 by being axially guided from the lead-in passage 21 is captured by the moisture trap 28 and the gaseous component thereof passes through the moisture trap 28, comes out on the side of a rear face of the impellers and is then led to the emitting port 23 by being guided toward the outside in the radius direction by a rotary absorbing force of the impellers 25. Thereby, only the non-reacted oxidant gas component is separated from water and is efficiently circulated within the polymer electrolyte fuel cell system 1.

As described above, the moisture trap 28 is provided around the center of the front face of the impellers 25 so as to rotate with the impellers 25. Then, a disc-like or cylindrical water collecting section 30 disposed so as to surround the moisture trap 28 and having a large diameter portion, i.e., a water collecting recess, is provided around the outer periphery of the moisture trap 28. The water collecting section is constructed so that a rear edge thereof is fixed to the front face of the impellers and a front edge thereof extends around the intake port 22 of the pump casing 24 so as not to guide the moisture mixture from the outlet port of the oxidant electrode guided to the intake port by bypassing the moisture trap 28. The water collecting section 30 rotates together with the impellers and stores water drained out of the moisture trap 28 by the rotation of the impellers in a state of receiving the centrifugal force.

The pump casing 24 has a front pump casing 31 having a shape of cone and having the intake port at the front end portion and a rear pump casing 32 whose front end junctions with the front pump casing 31 and whose rear edge is coupled with a motor casing 33 storing the motor 34. The front pump casing 31, the rear pump casing 32 and the motor casing 33 are coupled by bolts in the present embodiment. A rotary shaft 35 of the motor 34 is coupled with the rotary shaft 26 of the impellers 25 so as to be able to transmit power. Thereby, the rotary power of the motor 34 is transmitted to the rotary vanes, i.e., the impellers 25, when the motor 34 is activated.

The casings 31 and 32 cover the part of the impellers and the motor section 19 to form a closed space so that neither produced water nor non-reacted gas dissipate.

Furthermore, according to the arrangement of the present embodiment, there is provided the drainage mechanism, i.e., the drainage valve 27, for draining water in the water collecting section 30 out of the water collecting section 30. The drainage mechanism 27 of the present embodiment has the water collecting section 30 disposed so as to cover the surrounding of the moisture trap 28 so that water captured by the moisture trap 28 does not flow to the gas side. Referring now together with FIG. 4, there is provided a Pitot tube 38 such that one end thereof is attached by leaving a slight gap from a bottom plate of the water collecting section 30 and another end thereof is attached to a drain port 36.

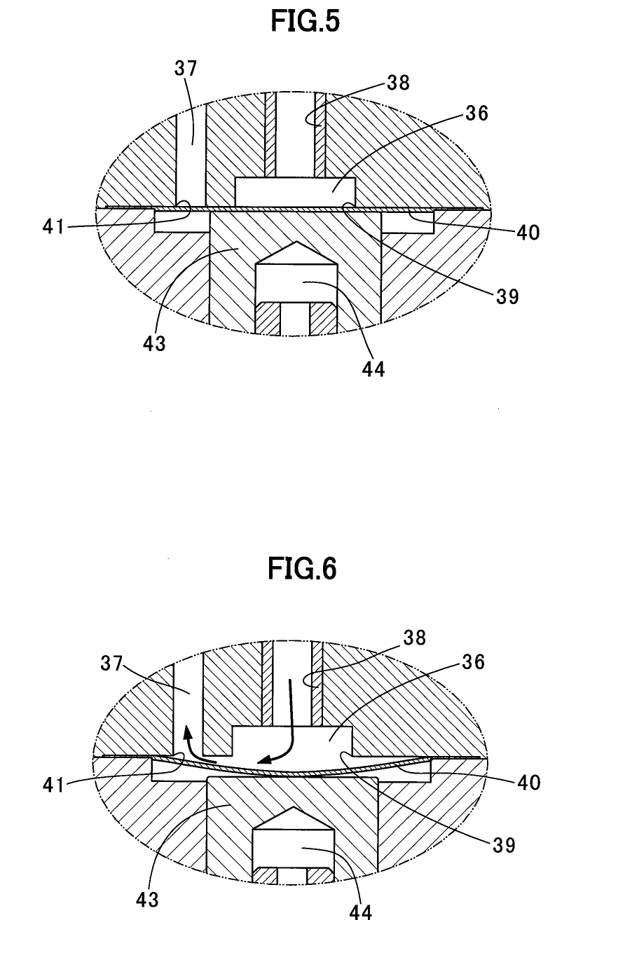

According to the arrangement of the present embodiment, there are provided the drain port 36 for draining water from the water collecting section 30 and a drain passage 37, provided in close proximity to the drain port 36, for draining water from the drain port 36. In this case, the drain port 36 and the drain passage 37 are provided in close proximity and almost in parallel as shown in FIGS. 5 and 6. Then, the Pitot tube 38 that communicates with the water collecting section 30 by opening one end thereof within water of the water collecting section 30 communicates with an outlet port of the drain port 36. The Pitot tube 38 plays a role of suctioning the produced water stored within the water collecting section 30 by hydraulic pressure to guide to the drain port 36. According to the arrangement of the present embodiment, an outlet-side opening 39 of the drain port 36 is provided within a common plane with an inlet-side opening 41 of the drain passage 37. Then, there is provided a sheet member 40 capable of closing or opening the both opening ends 39 and 41 according to the arrangement of the present embodiment.

When the hydraulic pressure within the Pitot tube 38 is low as shown in FIG. 5, the sheet member 40 closely adheres to the outlet-side opening end 39 of the drain port 36 and the inlet-side opening end 41 of the drain passage 37 and closes the outlet side of the drain port 36 and the inlet-side opening end 41 of the drain passage 37. However, when the hydraulic pressure within the Pitot tube 38 increases as shown in FIG. 6, the sheet member 40 elastically deforms and separates from the opening ends. It then communicates the outlet-side opening end of the drain port 36 with the inlet-side opening end of the drain passage 37 intermittently or continuously to discharge the water in the drain port 36 to the drain passage 37.

Water from the drain port 36 may be selectively drained to the drain passage 37 and moisture may be effectively separated from the gaseous component without emitting the gaseous component by the operation of the sheet member 40. The sheet member 40 is composed of a panel member having a degree of flexibility of guaranteeing the operation described above and Teflon (registered mark) formed into a thin sheet is used.

According to the arrangement of the present embodiment, there is provided an urging member, e.g., a spring in this example, disposed behind the sheet member 40 in contact for urging the sheet member 40 to the opening of the drain port 36 by its elastic force. A pressing member 43 having a flat surface is disposed at an edge of the spring 42 to press the back of the sheet member 40 and to give a desirable urging force. The urging force of the spring 42 may be uniformly transmitted to the sheet member 40 by arranging such that the flat surface of the pressing member closely contacts with the back of the sheet member 40 across almost the whole surface thereof and by giving the elastic force by the spring 42. The flow of water from the drain port 36 to the drain passage 37 is thus made smooth.

Furthermore, according to the invention, there is provided a space 44, that is shut down from the outside, behind the spring 42 and a pressure regulating tube, i.e., a pressure equalizing tube 45, that communicates the space with the space or the lead-in passage within the pump casing 24.

Thereby, even if the pressure fluctuates within the pump casing 24, it is possible to drain the produced water to the outside of the system without being affected by that in response to the hydraulic pressure corresponding to the centrifugal force of the water collecting section 30.

The operation of the polymer electrolyte fuel cell system 1 of the present embodiment will be explained below.

At first, the moisture mixture containing the produced water and non-reacted gas from the oxygen emitting port 15 is sent to the impellers 25 via the intake port 22 of the pump casing 24 of the circulating pump 17. The rotary shaft 26 of the impellers 25 is coupled with the rotary shaft 35 of the motor 34 within the pump casing 24 and is rotated by the power of the motor 34. In this case, the moisture mixture is led through the tubular lead-in passages 20 and 21 extending along the rotary shaft 26 of the impellers 25 in the direction orthogonal to the impellers 25. Then, the moisture mixture collides against the moisture trap 28 composed of the porous material attached to the intake-port side, i.e., the front side, of the impellers 25 from the front. The moisture trap 28 effectively traps moisture within the moisture mixture from the oxygen emitting port 15.

Because the moisture trap 28 and the water collecting section 30 are both attached to the impellers 25, they rotate together with the impellers 25. Therefore, the water trapped by the moisture trap 28 is pushed from the center to the outside by the centrifugal force of the rotation. By being pushed out, the water discharged out of the moisture trap 28 and splashed hits against the inner wall of the water collecting section 30, gathering in the water collecting section 30. Because the water collecting section 30 itself is also rotated, it receives the centrifugal force as well. Therefore, the water trapped within the inner face of the water collecting section 30 gathers to the large diameter portion of the water collecting section 30 having a large inner diameter, i.e., a large radius of rotation. One end 47 of the Pitot tube 38 extends to the large diameter portion 46 as shown in FIG. 4 and in this case, the Pitot tube 38 extends to a degree that one end opens below the surface of water collected in the large diameter portion 46. Thereby, when water in the water collecting section 30 gathers more than a certain amount, the end 47 of the Pitot tube 38 sinks below the water surface (FIG. 4). While pressure of the space of the water collecting section 30 is equal to that of the lead-in passage 21 to the circulating pump 17, force caused by a difference of water levels between the end 47 of the Pitot tube 38 and the water surface and caused by the centrifugal force due to its rotation is added to the pressure of the gas part of the end 47 of the Pitot tube 38 when water gathers in the water collecting section 30. Then, the following equation holds when an immersion depth of the Pitot tube into the collected water is h;
F(water collecting section*drain port)=m(h)×rω² (a)
where m(h) is a mass dependent on the height of the water level from the opening end 47 of the Pitot tube 38, r is a radius of rotation and ω is an angular velocity.

Meanwhile, the pressure of the space 44 of the sheet member 40 on the side of the pressing member 43 is equalized by the pressure equalizing tube 45, so that the pressure of this part is equal with the pressure within the lead-in passage 21 to the circulating pump 17. The pressure of the space 44 behind the pressing member 43 is equal to the pressure of the space within the water collecting section 30 in a state when no water gathers in the large diameter portion 46 of the water collecting section 30, so that the sheet member 40 is pressed against the outlet-side opening 39 of the drain port 36 which communicates with the other end of the Pitot tube 38 and the inlet-side opening 41 of the drain passage 37. Then, the sheet member 40 closes the opening ends of the drain port 36 and the drain passage 37 by closely adhering to the peripheral edges of the both, thus shutting down the communication of the both openings 39 and 41 by the following equation:
F(drain passage)=kx (b)
Where, k is a spring constant and x is a value of displacement due to pressurization given in advance. Then, when water gathers in the large diameter portion 46, the water level rises and covers the opening end 47. When the water level rises above the opening end 47, pressure is added to the opening end 47 of the Pitot tube 38. At this time, the following equation holds:
F(water collecting section*drain port)>F(drain passage) (c).

When the hydraulic pressure on the side of the drain port 36 exceeds the force of the spring 42 for pressing the sheet member 40, the sheet member 40 is displaced by being pressed by the hydraulic pressure so as to separate from the opening ends 39 and 41 and spatially communicates the ends of the Pitot tube 38, the drain port 36 and the drain passage 37 that have been disconnected by the sheet member 40 that has closely adhered to the both opening ends 39 and 41 of the drain port 36 and the drain passage 37 as shown in FIG. 6.

Because the Pitot tube 38, the drain port 36 and the drain passage 37 are connected from each other, water in the water collecting section 30 flows to the side of the drain passage 37 via the Pitot tube 38 by the difference of pressure of water and only water is drained effectively. The non-reacted oxidant gas existing in the space of the water collecting section 30 stays within the pump casing 24.

Then, the water is drained on the basis of such difference of pressure of water as the drain port 36 communicates with the drain passage 37 and the water level drops to a level more than a predetermined value and the following equation holds:
F(water collecting section*drain port)<F(drain passage) (d).
Then, when the pressure generated within the water collecting section 30 by water becomes smaller than the pressurizing force of the spring 42, the sheet member 40 is pressed again to the side of the opening ends of the Pitot tube 38, the drain port 36 and the drain passage 37 by the pressing member 43 and shuts down the communication among the Pitot tube 38, the drain port 36 and the drain passage 37, stopping the flow of water again.

It is then possible to separate only water within the moisture mixture from the non-reacted oxidant gas, to guide to the drain passage 37 and to discharge to the outside of the system by regulating the force of the spring 42 to keep the state in which the water level is higher than the opening end 47 of the Pitot tube 38. Because the arrangement of the present embodiment described above allows moisture to be efficiently separated without emitting gas, the non-reacted oxidant gas may be circulated within the closed loop system without trouble.

According to the arrangement described above, the hydraulic pressure is generated by the centrifugal force and the moisture of the moisture mixture is separated from the gas based on that, so that the arrangement may be effectively incorporated and actively used in the fuel cell system even under the micro-gravity. Still more, the whole moisture mixture is guided to the moisture trap 28 composed of the porous material to trap moisture and to transmit the gaseous component in the arrangement of the present embodiment, so that the structure may be simplified and the moisture may be effectively separated from gas.

A safe moisture separating apparatus may be realized by using a brushless motor that will cause no explosion even in a case when concentration of combustion supporting oxygen gas is high for the motor section. Still more, the motor section 19 may be separated from the pump section 18 by constructing the circulating pump by using a magnet motor as a driving source. Then, there is a merit that the pump will cause no fire nor explosion even in the oxidant (combustion supporting gas) by driving the circulating pump 17 in the separated state.

Accordingly, the pump may be utilized for circulating the combustion supporting gas by adopting the magnet motor.

Still more, an amount of drained water may be regulated by adequately regulating the number of revolutions of the impellers, so that it is possible to downsize the moisture separating apparatus. It is also possible to downsize the whole fuel cell system because the circulating pump and the moisture separating mechanism may be integrated according to the arrangement of the embodiment. Accordingly, this is an effective moisture separating technology in the fuel cell generation in a limited space whose connection with the outside world is restricted such as a closed environment on the ground, not only in the micro-gravity environment.

Furthermore, although the moisture separation in the oxidant system has been illustrated in the present embodiment, the similar circulating pump and moisture separating mechanism with those of the oxidant system may be applied when moisture separation is required in the fuel system.

As described above, the present invention may be preferably used in the fuel cell system used in the micro-gravity environment and is highly useful in fields of using gas circulating apparatuses. More generally, the present invention is expected to be actively used in fields of using moisture separating apparatuses.

Furthermore, the arrangement of the present invention exhibits various excellent effects such as improvement of performance of cells, reduction of operation cost and realization of high power generation.

What is claimed is:

1. A circulating pump for taking in a moisture mixture containing reaction produced water and non-reacted gas at least from either one of an fuel outlet port and an oxidant outlet port of a fuel cell and for refluxing said non-reacted gas to an inlet port of the gas of said fuel cell, comprising:
a pump casing having an intake port communicating with a lead-in passage for leading in said moisture mixture at least from either one of said fuel outlet port and oxidant outlet port of said fuel cell and a discharge port for sending said non-reacted gas to said inlet port of the gas of said fuel cell;
impellers disposed within said pump casing;
a moisture trap, provided around the center of a front face of said impellers so as to rotate together with said impellers, for trapping moisture within said moisture mixture led into said pump casing via said intake port;
a water collecting section, provided in communication with said moisture trap, for storing water drained out of said moisture trap by rotation of said moisture trap in a state of receiving centrifugal force; and
a drainage mechanism for draining water in said water collecting section out of said water collecting section.

2. The circulating pump according to claim 1, further comprising a drain port for draining water from said water collecting section and a drain passage, provided in close proximity to said drain port, for draining water from said drain port; and
said drainage mechanism comprises a Pitot tube whose one end communicates with said water collecting section by opening within water in said water collecting section and whose other end communicates with said drain port; and
a sheet member that closes an outlet port of said drain port and an inlet port of said drain passage by closely adhering to said outlet-side opening end of said drain port and said inlet-side opening end of said drain passage in a state when hydraulic pressure within said Pitot tube is low and that separates from said opening ends of said drain port and drain passage when the hydraulic pressure within said Pitot tube increases, communicating said outlet-side opening end of said drain port with said inlet-side opening end of said drain passage and discharging water in said drain port to said drain passage.

3. The circulating pump according to claim 2, further comprising an urging member, disposed closely behind said sheet member for pressing said sheet member toward said opening of said drain port by its elastic force.

4. The circulating pump according to claim 3, wherein a space is created behind said urging member and a pressure equalizing tube that communicates said space with said lead-in passage is disposed.

5. The circulating pump according to claim 1, wherein said moisture trap is composed of a gas transmitting porous material disposed so as to extend from a front part of said impellers at an end of said gas lead-in section and a rotary center part of said impellers toward the outside in a radial direction.

6. The circulating pump according to claim 1, wherein the moisture mixture containing produced water and non-reacted gas is guided to an intake port of said pump along a rotary shaft of said impellers, collides against said moisture trap at the front center part of said impellers, thus changing its advancing direction in an orthogonal direction along front walls of said impellers, is guided toward the outside in the radial direction and to the emitting port of said pump casing.

7. The circulating pump according to claim 1, wherein an output shaft of a magnet motor is coupled to said impellers so as to be able to transmit power.

8. The circulating pump according to claim 1, wherein an output shaft of a brushless motor is coupled to said impellers so as to be able to transmit power.

9. The circulating pump according to claim 1, wherein said circulating pump is used in a micro-gravity environment.

10. A drain valve, comprising:
a water collecting section capable of storing water receiving a centrifugal force;
a drain port for draining water from said water collecting section;
a Pitot tube whose one end communicates with said water collecting section by opening within water in said water collecting section and whose other end communicates with said drain port;
a drain passage, provided in close proximity to said drain port, for draining water from said drain port; and
a sheet member arranged so as to close both of an outlet port of said drain port and an inlet port of said drain passage by closely adhering to said outlet-side opening end of said drain port and said inlet-side opening end of said drain passage; wherein
said sheet member operates so as to close the both of said outlet port of said drain port and said inlet port of said drain passage by closely and concurrently adhering to said outlet-side opening end of said drain port and said inlet-side opening end of said drain passage in a state when hydraulic pressure within said Pitot tube is low and so as to intermittently communicate said outlet-side opening end of said drain port with said inlet-side opening end of said drain passage to discharge water in said drain port to said drain passage when the hydraulic pressure within said Pitot tube increases.

11. The drain valve according to claim 10, further comprising an urging member, disposed closely behind said sheet member for pressing said sheet member toward said opening of said drain port by its elastic force.

12. The drain valve according to claim 10, wherein a pressure equalizing tube that communicates said space provided behind said urging member with a space contacting with water of said water collecting section is disposed.

13. The drain valve according to claim 10, wherein said drain valve is used in a micro-gravity environment.

14. A fuel cell system, comprising:
a fuel cell for generating electric power through an electro-chemical reaction of gas supplied to a fuel electrode side with gas supplied to an oxidant electrode side; and
a circulating pump for taking in a moisture mixture containing reaction produced water and non-reacted gas at least from one of an fuel outlet port and an oxidant outlet port of said fuel cell and for refluxing said non-reacted gas to an inlet port of the gas, comprising:
a pump casing having an intake port communicating with a lead-in passage for leading in said moisture mixture at least from either one of said fuel outlet port and oxidant outlet port of said fuel cell and a discharge port for sending non-reacted gas to said inlet port of the gas;
impellers disposed within said pump casing;
a moisture trap, provided around the center of a front face of said impellers so as to rotate together with said impellers, for trapping moisture within said moisture mixture led into said pump casing;
a water collecting section, provided in communication with said moisture trap, for storing water drained out of said moisture trap by rotation of said moisture trap in a state of receiving centrifugal force; and
a drainage mechanism for draining water of said water collecting section out of said water collecting section.

15. The fuel cell system according to claim 14, wherein a closed circulating path is formed by connecting a gas emitting port at least from an oxidant electrode side among said fuel electrode and oxidant electrode to a path for supplying the gas to said oxidant electrode and a condenser is provided in said closed circulating path.

16. The fuel cell system according to claim 14, wherein said fuel and oxidant gases are supplied to said condenser from supply sources without moisture.

17. The fuel cell system according to claim 14, wherein said fuel cell system is used in a micro-gravity environment.
